(19) United States
(12) Patent Application Publication
(10) Pub. No.: US 2011/0031769 A1
(43) Pub. Date: Feb. 10, 2011

(54) BUMPER CROSS BEAM FOR A MOTOR VEHICLE

(75) Inventor: Mike Löeffler, Freiburg (DE)

Correspondence Address: URSULA B. DAY, ESQ., 708 Third Avenue, SUITE 1501, NEW YORK, NY, 10017, US

(73) Assignee: PEGUFORM GMBH, BÖTZINGEN (DE)

(21) Appl. No.: 12/863,957

(22) PCT Filed: Oct. 23, 2008
(86) PCT No.: PCT/EP08/08977

§ 371 Date: Oct. 15, 2010

(30) Foreign Application Priority Data
Jan. 22, 2008 (EP) 08001111.7

(51) Int. Cl. B60R 19/04

(52) U.S. Cl. 293/146

(57) ABSTRACT

The present invention refers to a bumper cross beam (1) which includes several sections having an increased height in the (Z) direction due to a vertical displacement of the central partial region 3 of the bumper cross beam.

The present invention refers to a bumper cross beam for the front- or rear area of a motor vehicle having the features as in the preamble of claim 1.

In order to sufficiently absorb the force that becomes effective upon the collision of two motor vehicles, without incurring considerable deformation of, for example, the passenger compartment, bumper systems are arranged in the front- and/or rear area of the motor vehicle at the level of the longitudinal beams and are connected thereto in order to pass the force via the bumper into the longitudinal beams. Since nowadays the height of even passenger cars vary greatly, upon collision of two motor vehicles it may be the case that the bumpers of the two vehicles do not strike each other and therefore the generated force is not optimally transmitted into the longitudinal beams. This can lead to considerable damage of the passenger compartment or damage to other functional construction elements in the front- and rear area of the vehicle. Thereby not only are the passengers endangered but usually the result is also considerable vehicle damage that causes correspondingly extensive repair costs.

To avoid the so-called “overrides” or “underrides”, the prior art proposes different solutions to avoid damage and to reduce costs. Thus, DE 10 2004 050 435 A1 proposes a bumper system for a motor vehicle where sufficient compatibility between motor vehicles of different heights is realized. For that purpose, surface planes of different heights are provided in a motor vehicle by which the forces generated from a collision are being distributed onto the different surface planes via a force distributing, element. Thereby, components are utilized as force absorption parts that are rigidly connected with the body of the motor vehicle or they form a part of the motor vehicle body. These force absorption elements are connected to force distribution elements, that are constructed flat and are arranged in front of the bumper cross beam in the front area of the motor vehicle. The force distribution elements are mostly of metal, preferably from steel or produced from an aluminum alloy. The entire system is relatively expensive and in addition, requires the use of relative expensive components in the front area of the motor vehicle where, in any case, already numerous functional elements of the motor vehicle are disposed such that there remains, in principle, very little space for placement.

In U.S. Pat. No. 7,066,525 B2, a bumper cross beam in the form of a collar bone is described, which includes two outer areas and a central area, wherein the central area in the driving direction is moved forward, or in the case of the bumper cross beam for the rear area, is moved rearwards. This configuration of the bumper cross beam is essentially dedicated for contact between the respective bumper cross beams in crash situation as early as possible, in order to better transfer the crash force as early as possible. While the bumper cross beam, in its central area is displaced forward in longitudinal direction, even in the case where the vehicles involved in the accident have different heights, and upon impact either an “underside” or an “override” of the bumper system takes place to possibly reduce the extent of damage, considerable damage still remains in this case.

There is thus a further need for a suitable bumper cross beam without the drawbacks of the prior art which provides in the case of a crash, optimized protection with relatively small expenditure of material and space even upon collision of the motor vehicles of different heights.

This object is solved by a bumper cross beam having the features of claim 1. Preferred embodiments of the bumper cross beam according to the present invention, are reflected in the dependent claims.

Within the scope of motor vehicle categories in different insurance classes, more and more crash tests are being conducted in order to estimate the extent of damage to be expected in the case of an accident. Thus, for example with the so-called RCAR-Bumper-Test (RCAR=Research Council for Automobile Repairs), minimum requirements are established for a bumper cross beam, where, upon fulfilling the requirements, in case of an accident, the risk of either driving “under” or “over’ the bumper system are prevented, or kept very low, and to thus keep repair costs correspondingly low. This test is composed such that the motor vehicle with a driving speed of 10.0+/−0.5 km/hr is driven with its front end or rear end against a test barrier firmly installed at a wall. Thereby, the test barrier is installed in a defined distance from the floor and has a height of 100 mm. A certification requirement for the RCAR-bumper test consists in the cross beams having a height of at least 100 mm such that covering of the cross beam with the test barrier is at least 75 mm.

To realize this degree of covering at this given reference height of the test barrier and to thus fulfill the criteria for new admissions that are applicable in 2010, the height of the bumper cross beam can correspondingly be increased. This however leads, depending on the height of the motor vehicle, to a not inconsiderable increase in weight.

The present invention is thus based on the idea that the bumper cross beam is usually arranged in an approximately straight line transverse to the driving direction, and thus, in a frontal collision, contact with the other motor vehicle happens almost simultaneously across the entire length of the bumper cross beam. In order to transfer the force of the collision into the longitudinal beams and thus keeping possible damage of the passenger compartment, or the functional components of the motor vehicle in the front- or rear low, it should be enough that the bumper cross beams of the other vehicles strike a partial area of the width of the vehicle front or rear. If however, the bumper cross beam is located at different heights along its length, then upon a frontal collision with the other vehicle, a high degree of overlap of the respective bumper cross beams can be realized without generally much of an increase of the cross section and thereby greatly the weight of the bumper cross beam.

The present invention thus provides a bumper cross beam for a motor vehicle which along it length, respectively the width of the motor vehicle, includes a total of three sections, of which the two outermost sections are configured identical, while the center section, relative to the two outer sections, is vertically displaced. By means of the vertical displacement of the center section of the bumper cross beam, the bumper cross beam gains in height in the Z-direction relative to its entire length or the total width of the motor vehicle. In a frontal collision where usually the bumper cross beams are approaching each other over the entire width of the vehicles, the possibility of meeting of the bumper cross beams is considerably increased even at different vehicle heights.

In an especially preferred embodiment of the present invention, the bumper cross beam, along its entire length, has essentially a constant cross section height, that continues also into the center area, via a vertical displacement. The result is that at relatively small general cross section heights of the bumper cross beam, the overlap requirements for a crash can be fulfilled. A small cross section height has the advantage leading to considerable weight savings as compared to a standard cross beam.

The vertical displacement of the center section of the bumper cross beam can be, depending on the design, directed in an upward or downward direction.

An advantageous embodiment of the bumper cross beam provides that the center section is vertically displaced upwards or downwards, whereby an “underride” or an “override” is being prevented.

In the transition area between the outer sections and the central section, the bumper cross beam preferably has the shape of a vertically displaced S-curve. A further advantageous embodiment provides that the two outer sections and the central section of the bumper cross beam are constructed of approximately equal length such that the additional height in Z-direction is gained through the S-curved transition area and the vertical displacement approximately after the first third of the cross beam. Thus, the additional height, independent of the angle of impact in almost all crashes in the front- and rear area of the vehicle, is realized. Besides these two afore-described embodiments of the transition area and the length ratio of the respective sections of the bumper cross beam, all possible geometrically acceptable embodiments resulting from the specific construction of the motor vehicle are possible.

In a further advantageous configuration of the present invention, which is somewhat less favorable regarding the savings in weight than the afore-described embodiment but which is easier to produce as a construction part and has additional advantages as compared to the afore-described variant relative to the stability and force transmission, the basic form of the bumper cross beam remains and the vertical displacement in the central area of the bumper cross beam consists in an upwards or downwards enlargement of the width of this area.

A further alternative of the present invention provides for the width enlargement in the central portion in both vertical directions. In this embodiment, the overlap area with the colliding vehicle bumper is further extended and it is possible to more than double the original overlap area of a conventional embodiment. The additional increase in weight through doubling the width of the central section, can be balanced, or at least can be partly compensated by reducing the height of the cross sections of the outer sections of the bumper cross beam. Since these sections for the overlap with the colliding car are no longer relevant, they also do not require the minimum height of 100 mm for a sufficient overlap. The main task of the lateral area of the bumper cross beam consists in transferring the crash generated force into the longitudinal beams.

In a preferred embodiment of the present invention, the outer sections of the bumper beam are provided with attachment devices for attaching the bumper cross beam to the longitudinal beams of the vehicle. In an advantageous embodiment, these attachment devices are constructed as so-called crash boxes that serve to simultaneously absorb at least partially the impact energy.

A further preferred embodiment of the bumper cross beam according to the present invention provides that the cross section height of the cross beam, according to the RCAR-Bumper-Test, is about 100 mm. By varying the vertical displacement, it is possible to realize, independent of the design data for the motor vehicle, a degree of overlap without any problem.

Material for the bumper cross beam can be the usual material for components such as for example, plastics, fiber reinforced plastics, composite materials or metals.

In the following paragraphs, the present invention will be described in more detail by means of drawings, which show different embodiments of types of bumper cross beams in front view. Hereby is shown:

FIG. 1 a conventional bumper cross beam as an example for comparison;

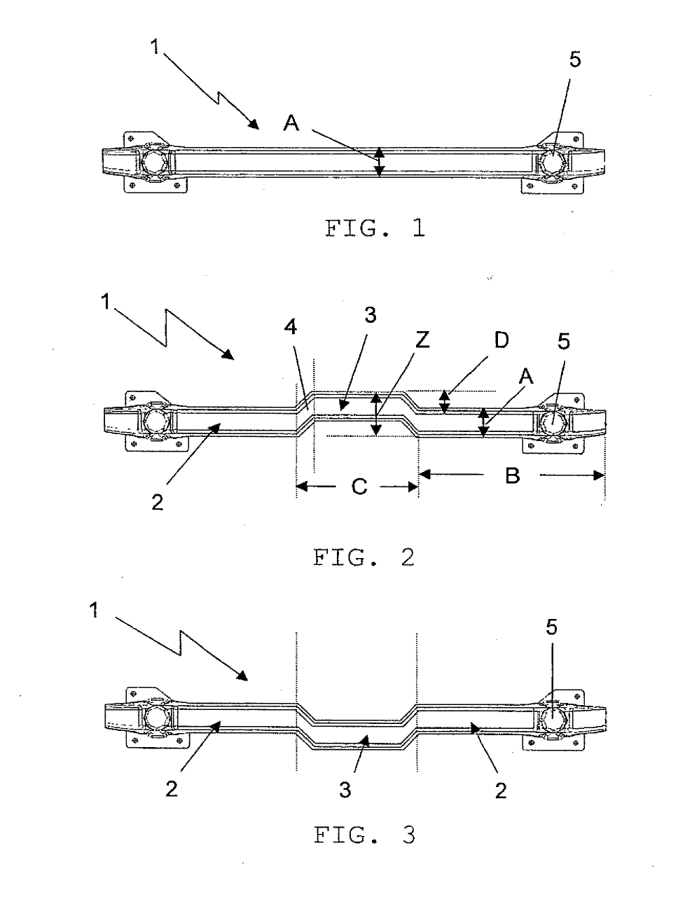

FIG. 2 a first embodiment of a bumper cross beam according to the present invention with an upward vertical displacement;

FIG. 3 an embodiment corresponding to embodiment as in FIG. 1; however with a downward vertical displacement;

FIG. 4 an embodiment of the bumper cross beam according to the present invention with a vertical upward widening;

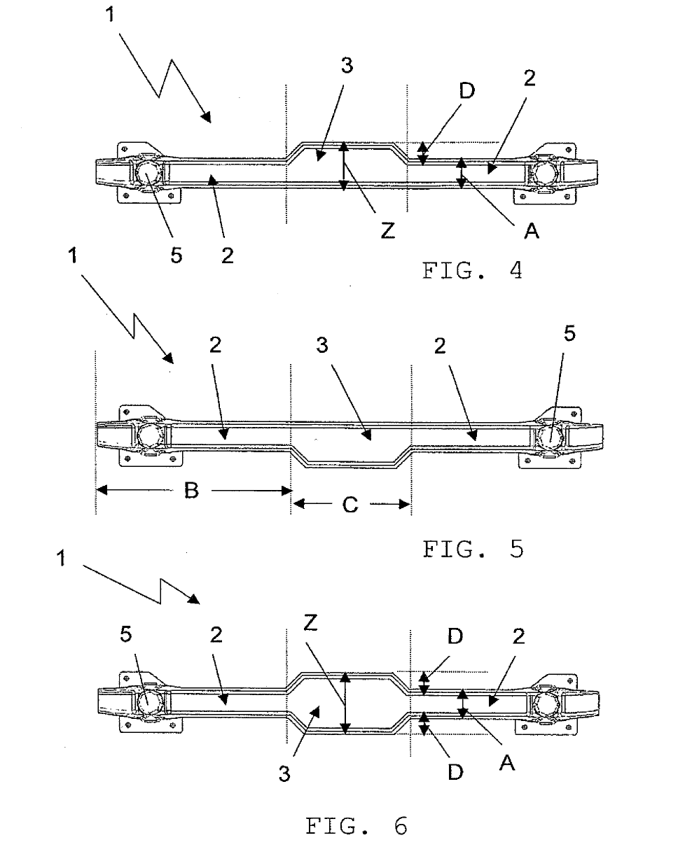

FIG. 5 an embodiment corresponding to FIG. 4, however, with a vertical downward widening; and

FIG. 6 a further embodiment of a bumper cross beam according to the present invention with a widening of the bumper cross section in both vertical directions.

FIG. 1 shows for comparison reasons the front view of a conventional bumper cross beam 1 in a linear embodiment showing the cross section height (A) unchanged along the entire length of the beam. In the lateral sections, attachment devices 5 are shown by means of which the bumper cross beam is attached to the longitudinal beam of the motor vehicle body.

FIG. 2 also shows the bumper cross beam 1 according to the present invention in a front view. Bumper cross beam 1 which exhibits essentially a constant cross section height (A), is constructed essentially of a total of three partial sections 2, 3, which consist of two of the same outer sections 2 and a different center section 3. The center section 3 is vertically displaced upwardly relative to the outer sections 2, whereby the vertical displacement (D) in this case corresponds approximately to the cross section height (A) of the bumper cross beam 1. Through the vertical displacement (D), the area of overlap of the bumper cross beam 1 increases from cross section height (A) to the height (Z). The transitional area 4, between the respective outer sections 2 and the center section 3, has the shape of a vertically displaced S-curve, wherein the transitional area 4 has a relative small measurement as compared to the longitudinal extensions B and C of sections 2, 3. The two outer sections 2 and the center section 3, in this particular case, possess a comparable longitudinal extension B and C which are configured such that in a third of the length of the bumper cross beam 1, the increased height (Z) of bumper cross beam 1 becomes evident. At each of the outer sections 2, attachment devices are provided for attachment of the bumper cross beam 1 to each of the longitudinal beams of the motor vehicle. Usually, the attachment device 5 is a cashbox.

FIG. 3 shows a variant embodiment of the bumper cross beam 1 according to the present invention, which corresponds to the one shown in FIG. 1, where the cross section height (A) of the bumper cross beam 1 remains unchanged. As compared to the FIG. 1, however, the central section 3 is now vertically displaced in a downward manner.

FIG. 4 shows a further embodiment of the bumper cross beam according to the present invention 1, where the linear basic shape of the bumper cross beam 1 remains the same, while the central section 3 is vertically widened. In that case, the cross section height (A) of the bumper cross beam 1 is increased in the central section 3 by the vertical displacement (D) and thus corresponds to the increased height (Z) of the bumper cross beam 1, while in the lateral sections 2, the original cross section height (A) remains. In this embodiment, an optimal transfer of force to the longitudinal beams of the motor vehicle via the attachment devices is realized.

FIG. 5 shows a variant embodiment corresponding to the bumper cross beam 1 as in FIG. 1, where the widening of the central section 3 is shown in downward manner.

The embodiment of the present invention as illustrated in FIG. 6 is somewhat of the special type since here, the central section 3 is widened in both vertical directions. This results in a twofold vertical displacement (D) and a central section 3 having a much increased height (Z) in the bumper cross beam 1.

### LIST OF REFERENCE NUMERALS

1 bumper cross beam
2 outer section
3 central section
4 transitional area
5 attachment device
A cross section height
B length outer section
C length central section
D vertical displacement
Z height

What is claimed is:

1.-6. (canceled)

7. A bumper cross beam for a motor vehicle comprising:
two identical shaped outer sections and
a central section which differs from the two outer sections, wherein the central section relative to the two outer sections is vertically displaced at least one of upwardly and downwardly.

8. Bumper cross beam according to claim 1, wherein the bumper cross beam along its entire length has essentially a constant cross section height, wherein the central section, as compared to the two outer sections is vertically displaced upwardly or downwardly.

9. The bumper cross beam according to claim 1, wherein the central section of the bumper cross beam has an enlarged cross section as compared to the two outer sections and is vertically displaced at least one of upwardly and downwardly.

10. The bumper cross beam according to claim 1, wherein the bumper cross beam in each transition area from an outer section to the central section is configured with a vertically displaced S-shaped curve.

11. The bumper cross beam according to claim 1, wherein the outer sections of the bumper cross beam each are provided with an attachment device for attaching the bumper cross beam to the longitudinal beams of the motor vehicle.

12. The bumper cross beam according to claim 11, wherein the attachment devices are constructed as crash boxes.
